(19) United States
(12) Patent Application Publication
(10) Pub. No.: US 2026/0151780 A1
(43) Pub. Date: Jun. 4, 2026

(54) APPARATUS AND METHOD FOR THE RECOVERY OF FINE HEAVY MINERALS

(71) Applicant: AJ Min Inc., Brandon (CA)

(72) Inventor: Aaron James Gunson, Brandon (CA)

(21) Appl. No.: 18/963,921

(22) Filed: Nov. 29, 2024

(51) Int. Cl. B03D 3/00

(52) U.S. Cl. CPC B03D 3/00; B03D 2203/025

(57) ABSTRACT

An industrialized process for recovering fine heavy minerals such as gold from particulate ore includes guiding a liquid slurry over an inclined surface with components thereon such as blankets, corduroy, carpet, canvas, magnetic mats, ribbed rubber mats, fine carpets, or like material which collect the heavier material and in a cleaning cycle releasing the trapped particles for collection by applying sequentially water jets from a plurality of water spray nozzles. Continuous operation can be obtained by installing surfaces in parallel, with an automated valve arrangement to divert feed away from a selected one of the surfaces when in the cleaning cycle. The surfaces are stacked one on top of another to increase feed capacity where the feed supply is arranged to feed to all stacked surfaces as a common supply and wherein the feed, water spray, concentrate, and tailings automated control valves are shared between the surfaces.

### TECHNICAL FIELD

This invention relates to an apparatus and method to be used in mining, and more particularly to the recovery of fine heavy minerals, including fine gold, from mineral slurry streams.

### BACKGROUND OF THE INVENTION

Various mechanical procedures have been used and proposed for the purpose of recovering fine heavy minerals. A common method, particularly for gold, is the use of a sluice. Traditional sluices are generally wood or metal troughs constructed with cross bars or riffles which allow heavy minerals to be trapped against the riffles. Underneath or between the riffles, expanded metal and/or a variety of mats or carpets are used to help capture and hold the target minerals. Heavy minerals are captured due to the difference in density of gangue (waste) minerals versus the targeted heavy minerals. The actual recovery mechanisms are complex: One of the key mechanisms is that the riffles introduce concentration vortexes in the slurry, wherein heavy minerals are driven into the bed of the sluice, directed by centrifugal and gravitation forces. Sluices require batch operations-after a set period, usually lasting hours, feed to the sluice must be stopped. The riffles, mats, and/or other capture media must then be disassembled and washed to remove and recover the trapped heavy minerals. Sluices can range between 5 feet and 100 feet in length, with a slope between 5° and 15°. Sluice feed capacity is driven by its width, which can be as small as a few inches to several feet wide.

A similar traditional method of recovering heavy minerals from fine slurry is the strake, with fine slurry defined herein as a mixture of water and mineral particles generally less than 150 microns in size. A strake is a shallow sloping trough with a textured surface, such as blankets, corduroy, carpet, canvas, or like material. All these materials act similarly to riffles on a sluice, but they have shallower depressions, which are sufficient to hold concentrate against the force of the slurry flowing through the trough, but not deep enough to form much of a bed. Recovery is based both on film sizing and sluicing, depending on the bottom surface and the conditions of operation. Film sizing is a form of gravity concentration driven by the difference in resistance to the scouring action of the feed slurry to particles of a similar size with different specific gravities. Strakes traditional ranged between 5 feet and 50 feet long, with a slope between 5° and 10°. Various efforts have been made to improve and/or automate strakes, such as H. P. Holland's ore concentrator, disclosed by U.S. Pat. No. 416,704 in 1889, G. L. Cudner's ore concentrator, disclosed by U.S. Pat. No. 473,449 in 1892, Joseph Dimmick's ore concentrator, disclosed by U.S. Pat. No. 554,914 in 1896, or more recently William Hibbard's gold and silver separator, disclosed by U.S. Pat. No. 4,352,733 in 1982. If the feed material contains a portion of magnetic minerals, a magnetic mat can be used as the surface, as disclosed by U.S. Pat. No. 5,927,508 by David Plath in 1997.

While sluices are still often used at placer mines, processing gravels, sluices and strakes are no longer typically used at hard rock mines, having been replaced by more modern methods, such as jigs, centrifugal concentrators, flotation, and/or cyanidation. Key limitations for sluices and strakes are that they have low processing capacities, require a large area of floor space, and are batch operations requiring extensive time for cleaning. Neither have been modified to handle the requirements of a contemporary automated plant.

The terms strake or sluice as used herein relate to any surface which is inclined from a feed end to a discharge end and includes components thereon arranged such that heavier particles including fine gold are trapped on the surface while tailings pass over the surface to an exit from the surface. The components to provide the trapping action can be any form or combination of textured surface such as blankets, corduroy, carpet, canvas, ribbed rubber mats, fine carpets, magnetic mats, or like material.

### SUMMARY OF THE INVENTION

It is one object of the present invention to provide an improvement in the operational characteristics of an apparatus of the above type which enables it to be used in an industrial arrangement.

It is known that strakes have been historically used to capture fine heavy minerals lost through the primary mineral processing recovery technologies, such as gravity, flotation, or cyanidation. However, prior to the present invention, to our knowledge, no current commercial hard-rock mining operations are using strakes, due to the lack of an arrangement suitable to current industrial practice.

According to a first aspect of the invention there is provided a method of recovering heavy minerals from particulate ore, comprising:
creating a feed supply of a liquid slurry of particulate ore;
guiding the liquid slurry of particulate ore to flow over at least one surface which is inclined from a feed end to a discharge end;
said at least one surface having components thereon arranged such that heavier particles including the fine gold are trapped on the surface while tailings pass over the surface to an exit from the surface;
in a cleaning cycle periodically halting the flow of the slurry for extracting the trapped particles;
and releasing the trapped particles from the surface for collection by applying to the surface water jets from a plurality of water spray nozzles.

According to a second aspect of the invention there is provided a method of recovering minerals from particulate ore, comprising:
creating a feed supply of a liquid slurry of the particulate ore;
guiding the liquid slurry of particulate ore to flow over at least one surface which is inclined from a feed end to a discharge end;
said at least one surface having components thereon arranged such that heavier particles are trapped on the surface while tailings pass over the surface to an exit from the surface;
in a cleaning cycle periodically halting the flow of the slurry for extracting the trapped particles;
wherein there are at least two surfaces so that the feed supply can be selectively fed to each of the surfaces and providing continuous operation by installing said at least two surfaces in parallel, with an automated valve arrangement to divert feed away from a selected one of the surfaces when in the cleaning cycle.

According to a third aspect of the invention there is provided a method of recovering minerals from particulate ore, comprising:
creating a feed supply of a liquid slurry of the particulate ore;
guiding the liquid slurry of particulate ore to flow over at least two surfaces which are inclined from a feed end to a discharge end and which are arranged in parallel;
said at least one surface having components thereon arranged such that heavier particles are trapped on the surface while tailings pass over the surface to an exit from the surface;
in a cycle periodically halting the flow of the slurry for extracting the trapped particles;
wherein said at least two surfaces are stacked one on top of another to increase feed capacity where the feed supply is arranged to feed to all stacked surfaces as a common supply and wherein tailings and control valves are shared between the surfaces.

The present arrangement as disclosed herein provides a method of recovering fine heavy minerals from a slurry using an automated system. The slurry flows over more than one stacked textured surfaces (rougher surfaces) where the heavy minerals are captured and the waste stream (tailings) flows over the end of the surfaces where it is collected in a discharge launder with an opening directing the tailings to their next destination. On a regular basis, determined by time or another measurement, feed to one of the stacked surfaces is stopped, the tailings valve at the end of the discharge launder is closed and an adjacent concentrate valve is opened to a concentrate collection location. The other stacked surfaces continue receiving feed, insuring continuous operation. A cleaning cycle, consisting of an array of timed spray nozzles, then flushes the collected heavy mineral concentrate towards the concentrate collection location. After the flushing is complete, the tailings valve is opened, the concentrate valve is closed, and the stacked surface is ready to receive feed again.

In the preferred arrangement, if the concentrate is not yet of sufficient value to be commercially viable for sale or further processing by conventional methods, the concentrate is directed to more than one stacked textured surfaces (cleaner surfaces), which are similar to the rougher surfaces, only smaller and with shorter surface lengths. The tailings from the stacked cleaner surfaces are directed to the feed of the stacked rougher surfaces, creating a recirculating load.

Once the heavy mineral concentrate is collected, if necessary, it can be further upgraded through conventional methods, such as flotation or leaching, which may be preceded by regrinding the concentrate.

### BRIEF DESCRIPTION OF THE DRAWINGS

Embodiments of the invention will be described below in conjunction with the accompanying drawings in which:

FIG. 1 is an isometric view of an apparatus according to the invention, with the surface covered with a textured surface, with a feed distribution system, a spray bar cleaning system, and a discharge.

FIG. 2 is a schematic illustration of a continuous system according to the invention using two parallel surfaces and a cleaning system using water spray nozzles which operate during cleaning cycles.

FIG. 3 is a perspective view from the rear and one side of a stacked apparatus structure according to the invention.

FIG. 4 is cross-sectional view through the stacked apparatus of FIG. 3 according to the invention.

FIG. 5 is a side perspective view of a feed distributor for the apparatus of FIG. 3 according to the invention

FIG. 6 is a graph of gold recovery versus surface length.

FIG. 7 is a graph of gold grade versus surface length.

FIG. 8. is a schematic illustration of the system according to the invention using parallel roughers and parallel cleaner surfaces.

### DETAILED DESCRIPTION

It is one object of the present invention to provide an improvement in the operational characteristics of a system of the above type which enables it to be used in a contemporary industrial arrangement,

There is provided herein a method of recovering fine heavy minerals, including chromium, copper, gold, iron, lead, nickel, silver, tin, zinc, or platinum group bearing minerals from particulate heavy mineral-bearing ore or a mineral product, such as a mineral processing plant tailings stream.

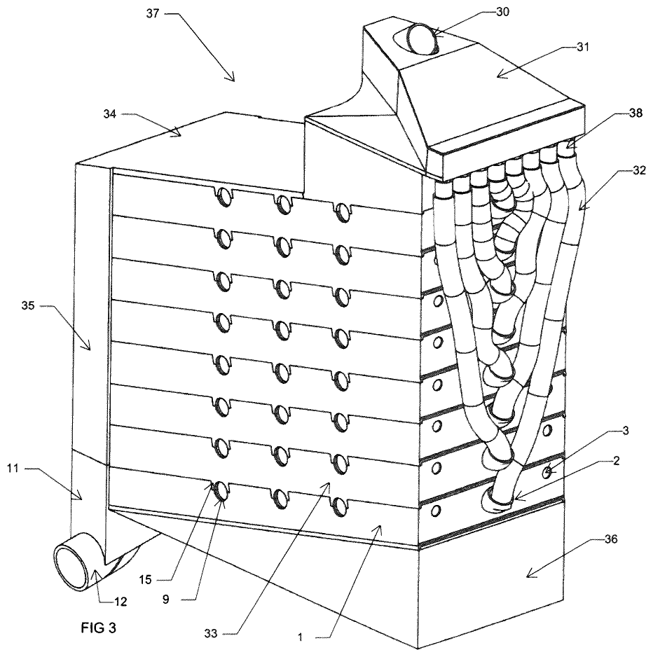

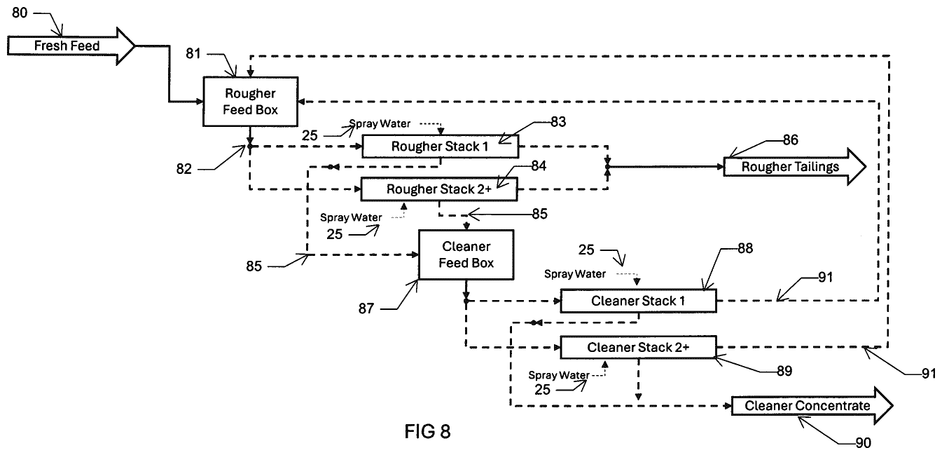

A first step of the method, as shown in the schematic of FIG. 8 and in the detailed illustrations of an embodiment in FIGS. 3, 4 and 5, includes creating or collecting a feed supply 80 of a liquid slurry of finely ground particulate heavy mineral-bearing ore and directing the feed supply to a rougher feed box 81, which distributes the feed supply to a parallel series of more than one stacked rougher surface assemblies 83 and 84.

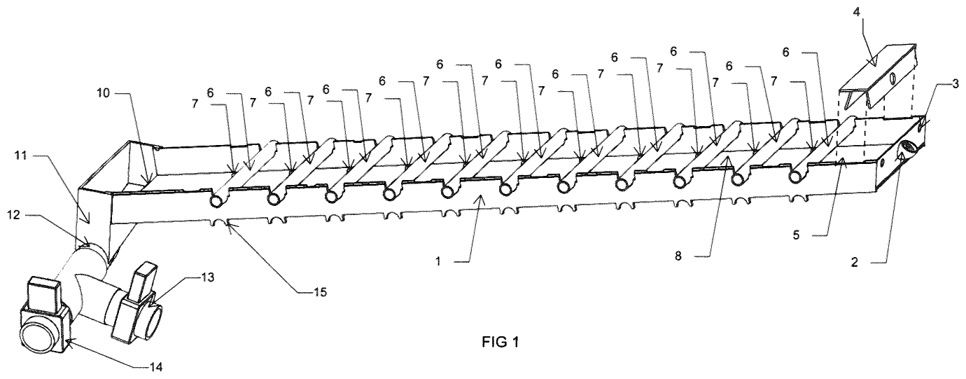

On each surface body 1 of the stacked assembly 37 (FIGS. 1 to 5) the liquid slurry of particulate heavy mineral-bearing ore is guided to flow over at least two rougher surfaces 8 which are inclined from a feed inlet 2 to a discharge edge 10. The surfaces are contained in a trough 1, or the surface body, made of metal, wood, plastic, or other rigid material, with walls high enough to contain the slurry. The body can be of a variety of widths and lengths so that for a rougher surface, a small unit can be around 8 inches wide by 56 inches long. When the slurry enters the feed inlet, it is important distribute the slurry evenly across the surface 8. This can be done several ways, but typically the system uses a feed distributor 4 which is an angled wear plate that slows down the inlet slurry and spreads it laterally, followed by a bare or smoothly lined portion of the surface, or feed plate 5, which allows the slurry to further distribute across the surface 8.

The system further includes spray bars 6 which are evenly spaced along the length of the body 1, with spray nozzles 7 attached to the bars 6. The bar spacing and nozzle spacing is dependant on the type of surface 8 and the mineral composition of the feed. It has been found that a bar spacing of in the range 2 to 8 inches and preferably around 4 inches, and a nozzle spacing of a distance in the range 2 to 12 inches and preferably around 8 inches so as to provide one nozzle per 8 inches of surface width, is generally sufficient. The spray bars 6 are inserted into spray bar openings 9 that are cut into the body 1. On the bottom of the body 1, are provided off set spray bar opening covers 15, which allow one body 33 to be placed on top of another body 1.

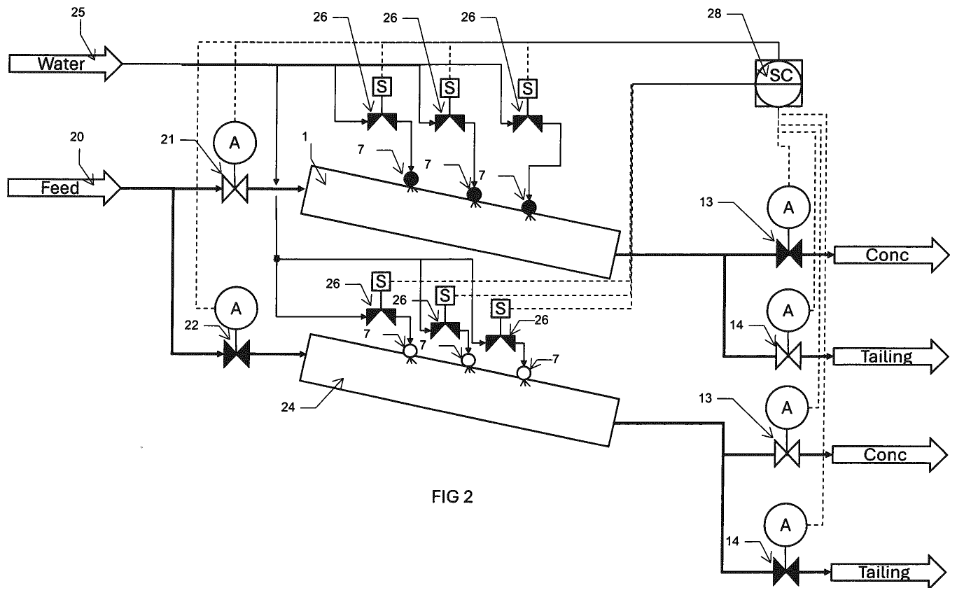

The bodies 1 are arranged such that the feed supply can be selectively fed to at least one of the surfaces and providing continuous operation by installing said at least two surfaces in parallel for example 1 and 24 as shown in FIG. 2, with an automated valve arrangement 21, 22 to divert feed away from a selected one of the surfaces when in the cleaning cycle.

The body surfaces 8 have a textured surface, such as blankets, corduroy, carpet, canvas, magnetic mat, or like material arranged such that heavier particles including the fine gold are trapped on the surface while tailings pass over the surface to an exit 10 from the surface as tailings. The tailings are collected in a discharge launder 11 and directed to a launder outlet 12. The outlet 12 is attached to a pipe Y-fitting, attached on the other ends to a concentrate automated isolation valve 13 and a tailings automated isolation valve 14. Vent holes 3 are provided at the inlet end of each body 1 to insure an adequate flow of air;

In a cleaning cycle, the system acts to periodically halt the flow of the slurry, by closing a selected one of the automated valves 21/22 to at least one body 1 for extracting the trapped particles, then closing the tailings automated isolation valve 14 and opening the concentrate automated isolation valve 13, thus changing the exit from the surface to a location to collect the concentrate. The flow of slurry remains uninterrupted to at least one surface 1 or 24 to maintain continuous operation.

After the flow is halted to a body 1, the trapped particles collected on surface 8 are released for collection by applying to the selected surface 8 water jets from the plurality of water spray nozzles 7 on the bars 6 by opening automated water isolation valves 26 to the individual bars 6. Each bar is associated with a respective valve 26 which are operated subsequentially, starting at the top of the body 1 so that the spray is sequentially supplied to the surface 8 from the top downward typically with each being turned off as the next is activated. The valves 26 are controlled by a common timer and control system 28.

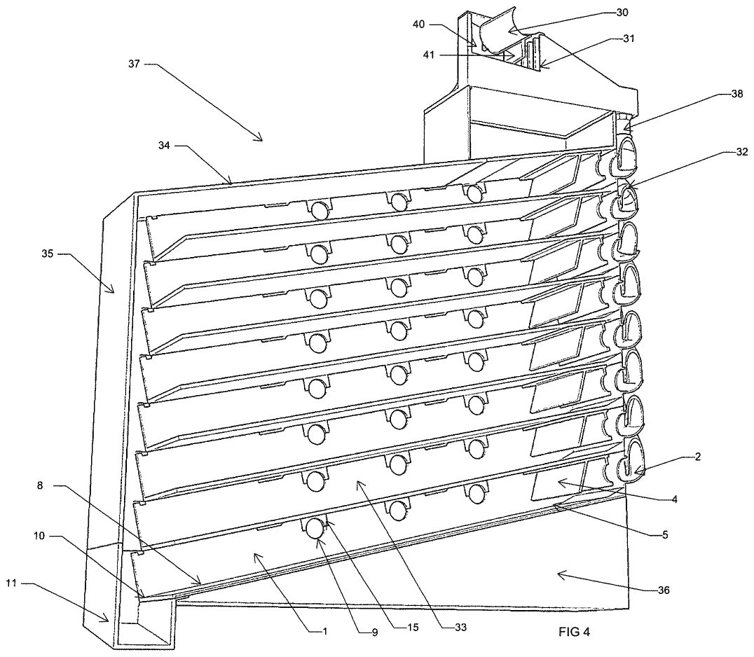

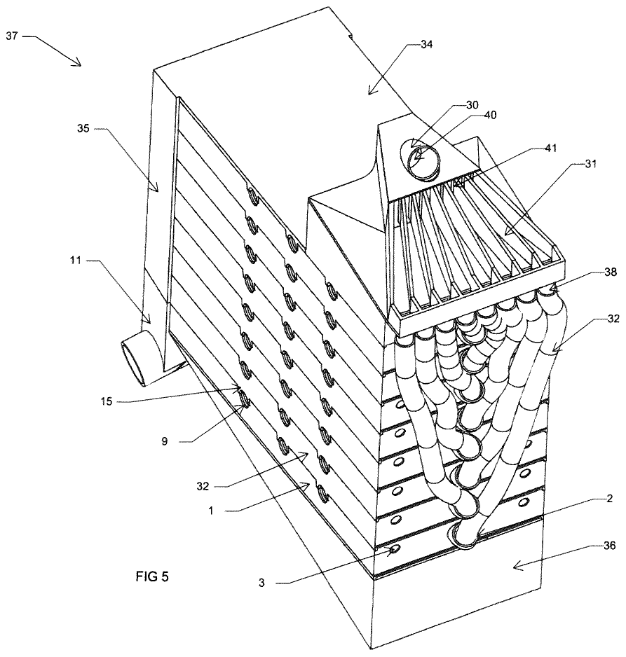

In this arrangement the bodies 1 are stacked one on top of another to form the stack assembly 37 to increase feed capacity. This is best shown in FIGS. 3 and 4 where the stacked assembly 37 includes a base frame 36 attaching the stack of surfaces or bodies 1 into a common frame structure and including a stack lid or cover 34 on the top body and a discharge launder cover 35. In this way, the feed control valves 21,22, the concentrate control valve 13, the tailings control valve 14, and water spray control valves 26 can be shared between all stacked surfaces. The bodies 1 are constructed such that the spray bar openings 9 on the top of a lower body 1 interlock with the spray bar opening cover 15 on the bottom of an upper one of the bodies, allowing the top body 33 to fit tightly over the next body 1 as shown in FIG. 3. This stacked arrangement requires a stack feed splitter 31 placed on top of the stack assembly. The stack feed distributor is fed by a hose inserted into the stack feed inlet 30. The feed slurry enters a feed distributor chamber 40 (FIGS. 4 and 5) and is forced into a stack feed distributor 41, prior to entering the feed splitter which defines a series of channels 31. The feed splitter 31 has several chambers or channels leading to the stack feed splitter discharge nozzles 38, which are connected to the top of the stack feed hoses 32. The stack feed hoses 32, direct the split slurry to the body feed inlets 2.

As shown in FIG. 8, the concentrate is treated in a similar arrangement on more than one dedicated shorter cleaner surfaces also in a parallel series of stack assemblies 88, 89, to achieve a higher grade of heavy minerals.

Preferably two or more stack assemblies each are arranged to form the rougher circuit 83, 84 and the cleaner circuit 88, 89, shown in FIG. 8, where the rougher concentrate 85 from the rougher circuit are fed to the cleaner circuit and the tailings 91 from the cleaner circuit are returned to the feed box 81 supplying the rougher units 83, 84. In particular, preferably the roughers and cleaners are arranged so as to maximize recovery with length and maximize grade, through cleaning, with a much shorter cleaner surface. In detail, the fresh feed supply of slurry 80, is fed to a rougher feed box 81, which also receives the cleaner circuit tailings 91, mixing to form a combined rougher feed slurry 82. The rougher feed slurry 82 is fed to more than one rougher stack 83,84 by pump or gravity. Each rougher stack has a feed control valve 21,22, to control if the stack is receiving feed or if feed is halted to the stack to allow for automated cleaning with water spray control valves 26. While a rougher stack is being fed 82, heavy mineral concentrate 85 is collected on all the body surfaces 8 and the tailings 86 flows out of the circuit through the discharge launder 11 and through the open automated tailings valve 14. When a rougher feed stack enters a cleaning cycle, the feed control valve 21 or 22 closes, stopping rougher feed slurry 82 from entering the stack, automated tailings valve 14 closes and automated concentrate valve 13 opens. Spray water 25 flows through the water spray control valves 26 through the spray bars 6 and spray nozzles 7, following the cleaning sequence. The rougher concentrate 85 then flows by gravity or is pumped to the cleaner feed box 87. Similar to the rougher feed box 81, the cleaner feed box feeds the rougher concentrate 85 to a number of cleaner stacks 88,89, with feed controlled by separate feed control valves 21,22. The higher grade heavy mineral cleaner concentrate 90 is collected on all the body surfaces 8 of the cleaner stacks and the cleaner tailings 91 flows to the cleaner discharge launder 11 and the open automated tailings valve 14. The cleaner tailings 91 is then pump or flows by gravity back to the rougher feed box. Using a similar cleaning cycle to the rougher stacks, the cleaner concentrate is pumped or flows by gravity out of the circuit as a final product or to the next stage of processing during cleaning cycles.

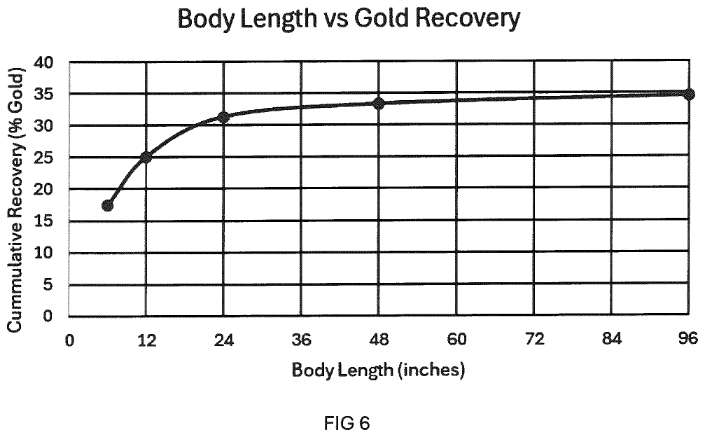

Optimum feed rates and feed slurry densities depend on the feed material. Optimum valuable heavy mineral recoveries were typically with surfaces 8 approximately 48″ long, but for some minerals the surface length could range from 24″ to 96″ long or longer, as shown in the graph of FIG. 6.

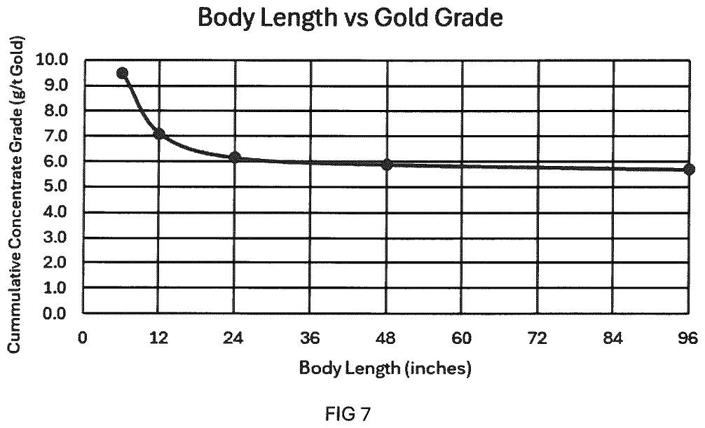

The highest heavy mineral grades are generally in the first 6 to 12 inches of the surface 8, as shown in the graph of FIG. 7. In one embodiment of a rougher-cleaner arrangement, the rougher surfaces 8 are 48″ length and the cleaner surfaces 8 are 12″ long, however, these can be adjusted to suit the feed material.

A key development made is that the heavy mineral concentrates can be removed with water sprays (7), as opposed to manually cleaning the surface. This allows the system to automate cleaning the concentrate, a critical component of industrialization. The water sprays 7 are turned on or off by automated water isolation valves 26. In an important feature the spray nozzles can be sequenced to control concentrate grade and recoveries as well: depending on the feed material, after the feed automated isolation valve 21 is closed, the initial sprays can wash the collected concentrate, removing lightly entrained gangue minerals to the tailings stream. Then the tailings automated isolation valve 14 is closed and the concentrate automated isolation valve 13 is opened, and the subsequent spray nozzles are opened in sequence, washing the cleaned concentrate toward the concentrate collection area. The water spray recovery system is suitable to any type of surface 8 that can be spray washed, that can also be used to collect the heavier materials. This may include textured surfaces, ribbed rubber mats, fine carpets, magnetic sheets, etc.

There have been many efforts in the past to automate cleaning of sluices or strakes, including using endless belts with a spray at the end, but it is believed that none specify an array of sprays over the surface of the sluice or strake.

Preferably the water spray nozzles 7 are arranged in an array over the surface 8 and arranged to direct the water jets onto the surface 8 from above. Preferably the water spray nozzles in the array are operated sequentially starting at the feed end.

Preferably the water spray nozzles are arranged on a plurality of spray bars 6 at spaced positions along the surface 8. In this arrangement, the spray bars 6 can be spaced by a distance in the range 2 to 8 inches and preferably around 4 inches. Also, the nozzles 7 can be arranged along the spray bars 6 are spaced by a distance in the range 2 to 12 inches and preferably around 8 inches. The nozzles 7 are typically operated for a time period in the range 1 to 6 seconds and preferably around 2 seconds. The height and angle of the nozzle 7 is important to achieve effective removal of the concentrate and depends on the type of nozzle, the available water pressure, the type of strake surface selected, and the type of concentrate collected. Generally, a nozzle angle of approximately 8 degrees relative to the surface is suitable. This can be in the range 6 to 10 degrees. Typically the tip of the nozzle 7 is approximately 0.9 inches above the surface 8, depending on the spray bar 6 height. The nozzle 7 tip height is typically in the range 0.75 to 1.25 inches. The bottom of spray bar 6 height is typically 0.7 inches above surface 8, ranging from 0.5 inches to 1 inch.

The next step to industrialization is finding a way for continuous feed. This has been resolved by placing two or more surfaces (1) in parallel, with an automated feed valve arrangement 21,22. Thus, the system feeds to one or more surfaces, while the system cleans a separate one, then alternate. A key part of this development was finding the optimum time required between cleaning cycles. This depends on the feed rate and the feed material but is in the range of 2 to 8 minutes. Control is based on timing where after a set period of time (2-8 minutes), a flush cycle will initiate. Feed is diverted to a second 84 unit via closing/opening automated feed valves 21,22, which are knifegate valves, pinch valves or similar. After a short period (1 to 10 sec), the concentrate automated isolation valve 13 valve, also knifegate valves, pinch valves or similar, open, and the tailings automated isolation valve 14 also knifegate valves, pinch valves or similar, close. The automated water isolation valves 26 then open up subsequentially for a short time (0.5-6 sec). An additional short period on the order of 2-6 seconds is allowed for the concentrate to drain to the outlet launder 12 and out the concentrate automated isolation valve 13. Then the concentrate automated isolation valve 13 valve closes, and the tailings automated isolation valve 14 opens and the surface 8 is ready to receive feed for the next cycle.

A further step to industrialization is finding a way to increase the feed capacity. This has been resolved by standing at least two surfaces 1,33 on top of another in a stacked assembly 37, where a stack feed splitter 31 is arranged to feed to all stacked surfaces from a common supply and wherein tailings valves 13 and concentrate valves 14 are shared between the surfaces. An 8″ wide surface optimal feed rate is 50-150 kg/h, depending on the feed material and slurry density. It was found that the minimum height required for a surface body 1 was around 2″. Thus, the bodies can be stacked to significantly increase the capacity. Additional capacity can also be gained by increasing the width of the surface. A single rougher unit 24″ wide with 24 separate levels would thus have a feed capacity of 3.6 to 10.8 t/h. A single rougher unit 48″ wide with 48 separate levels would have a feed capacity of 14.4 to 43.2 t/h. Providing even feed distribution 31,41 to each level and across each level 4,5, as described above, is important to achieving good performance.

1. A method of recovering minerals from particulate ore, comprising:
creating a feed supply of a liquid slurry of particulate ore;
guiding the liquid slurry of particulate ore to flow over at least one surface which is inclined from a feed end to a discharge end;
said at least one surface having components thereon arranged such that heavier particles including fine gold are trapped on the surface while tailings pass over the surface to an exit from the surface;
in a cleaning cycle periodically halting the flow of the slurry for extracting the trapped particles;
and releasing the trapped particles from the surface for collection by applying to the surface water jets from a plurality of water spray nozzles.

2. The method according to claim 1 wherein the water spray nozzles are arranged in an array over the surface and arranged to direct the water jets onto the surface from above.

3. The method according to claim 1 wherein the water spray nozzles in the array are operated sequentially starting at the feed end.

4. The method according to claim 1 wherein the water spray nozzles are arranged on a plurality of spray bars at spaced positions along the surface.

5. The method according to claim 4 wherein the spray bars are spaced by a distance in the range 2 to 8 inches and preferably around 4 inches.

6. The method according to claim 4 wherein the nozzles arranged along the spray bars are spaced by a distance in the range 2 to 12 inches and preferably around 8 inches.

7. The method according to claim 4 wherein the nozzles are operated for a time period in the range 0.5 to 6 seconds and preferably around 2 seconds.

8. The method according to claim 1 wherein the spray nozzles are arranged at an angle relative to the surface in the range 6 to 10 degrees and preferably of the order of 8 degrees to the surface and at a distance from the surface in the range 0.75 to 1.25 inches and typically of the order of 0.9 inches above the surface, and the bottom of the spray bars are typically 0.7 inches above surface 8, ranging from 0.5 inches to 1 inch.

9. The method according to claim 1 wherein the surface is textured or covered by a textured material, including ribbed rubber mats, fine carpets, magnetic mats or otherwise that collects heavy minerals and allows lighter minerals to flow over and off the surface.

10. The method according to claim 1 wherein said at least one surface comprises at least two surfaces so that the feed supply can be selectively fed to each of the surfaces and providing continuous operation by installing said at least two surfaces in parallel, with an automated valve arrangement to divert feed away from a selected one of the surfaces when in the cleaning cycle.

11. The method according to claim 10 wherein the optimum time period required between cleaning cycles is selected depending on the feed rate and the feed material in the range 2 to 8 mins and preferably around 4 mins.

12. The method according to claim 11 wherein said at least two surfaces are stacked one on top of another to increase feed capacity where the feed and water spray control valves are shared between all stacked surfaces.

13. The method according to claim 1 [symbol] wherein said at least one surface comprises at least two surfaces which are arranged to form a rougher and a cleaner where the tailings from the cleaner are returned to the feed supply to the rougher.

14. The method according to claim 13 wherein the rougher and cleaner are arranged so as to maximize recovery with length and maximize grade, through cleaning, with a much shorter cleaner surface.

15. A method of recovering heavy minerals from particulate ore, comprising:
creating a feed supply of a liquid slurry of the particulate ore;
guiding the liquid slurry of particulate ore to flow over at least one surface which is inclined from a feed end to a discharge end;
said at least one surface having components thereon arranged such that heavier particles are trapped on the surface while tailings pass over the surface to an exit from the surface;
in a cleaning cycle periodically halting the flow of the slurry for extracting the trapped particles;
wherein said there are at least two surfaces so that the feed supply can be selectively fed to each of the surfaces and providing continuous operation by installing said at least two surfaces in parallel, with an automated valve arrangement to divert feed away from a selected one of the surfaces when in the cleaning cycle.

16. The method according to claim 15 wherein the optimum time period required between cleaning cycles is selected depending on the feed rate and the feed material in the range 2 to 8 mins and preferably around 4 mins.

17. The method according to claim 15 wherein said at least two surfaces are stacked one on top of another to increase feed capacity where the feed control valve, the concentrate control valve, the tailings control valve, and the water spray control valves are shared between all stacked surfaces.

18. The method according to claim 15 wherein the surface is textured or covered by a textured material, including ribbed rubber mats, fine carpets, magnetic mats or otherwise that collects heavy minerals and allows lighter minerals to flow over and off the surface.

19. A method of recovering heavy minerals from particulate ore, comprising:
creating a feed supply of a liquid slurry of the particulate ore;
guiding the liquid slurry of particulate ore to flow over at least two surfaces which are inclined from a feed end to a discharge end and which are arranged in parallel;
said at least one surface having components thereon arranged such that heavier particles are trapped on the surface while tailings pass over the surface to an exit from the surface;
in a cycle periodically halting the flow of the slurry for extracting the trapped particles;
wherein said at least two surfaces are stacked one on top of another to increase feed capacity where the feed supply is arranged to feed to all stacked surfaces as a common supply and wherein a feed control valve, a concentrate control valve, a tailings control valve, and a water spray control valves are shared between all stacked surfaces.

20. The method according to claim 19 wherein said at least two surfaces are arranged to form a rougher and a cleaner where the tailings from the cleaner are returned to the feed supply to the rougher and wherein the rougher and cleaner are arranged so as to maximize recovery with length and maximize grade, through cleaning, with a much shorter cleaner surface.
